(19) United States
(12) Patent Application Publication
(10) Pub. No.: US 2023/0219822 A1
(43) Pub. Date: Jul. 13, 2023

(54) PHOSPHORUS ELEMENT-CONTAINING ZEOLITE AND METHOD FOR PRODUCING PHOSPHORUS ELEMENT-CONTAINING ZEOLITE

(71) Applicant: N.E. CHEMCAT CORPORATION, Minato-ku (JP)

(72) Inventors: Yukio TAKAGI, Minato-ku (JP); Yasuyuki BANNO, Minato-ku (JP); Kiyohiko SAITO, Minato-ku (JP); Hiroyasu SUZUKA, Minato-ku (JP); Yosuke IMANAKA, Minato-ku (JP); Takahiko ISHIKAWA, Minato-ku (JP)

(73) Assignee: N.E. CHEMCAT CORPORATION, Minato-ku (JP)

(21) Appl. No.: 17/996,054

(22) PCT Filed: Apr. 6, 2021
(86) PCT No.: PCT/JP2021/014613

§ 371 Date: Oct. 12, 2022

(30) Foreign Application Priority Data
Apr. 21, 2020 (JP) 2020-075072

(51) Int. Cl. C01B 39/46; B01J 29/06; B01J 37/02; B01J 29/70; B01D 53/86

(52) U.S. Cl. CPC C01B 39/46; B01J 29/06; B01J 37/0201; B01J 29/7015; B01J 29/7003; B01D 53/86; C01P 2006/16; B01D 2255/50; B01D 2255/9205

(57) ABSTRACT

A small-pore zeolite that is modified with phosphorus, is excellent in hydrothermal durability, and has an 8-membered oxygen ring structure. The 8-membered oxygen ring structure is CHA, AEI, and AFX. The small-pore zeolite incudes at least an aluminum element, a silica element, a phosphorus element, wherein the phosphorus element is defined by expression (1), and the small-pore zeolite has an 8-membered oxygen ring structure being of CHA, AEI, or AFX. The phosphorus element that modifies the zeolite is unevenly distributed and richly contained on the surface layer side of the zeolite. A method for producing a phosphorus element-containing zeolite.

### TECHNICAL FIELD

The present invention relates to a novel phosphorus element-containing zeolite and method for producing the same.

### BACKGROUND ART

Zeolites have a framework structure having regular pores with a fixed size and are used for various industrial purposes such as exhaust gas purification catalysts. Such zeolites are individually given codes of 3 alphabet letters according to their framework structures by International Zeolite Association (IZA).

Among such zeolites, small-pore zeolites of CHA, AEI, and AFX types having an 8-membered oxygen ring structure are known as catalytic materials for removing nitrogen oxide in exhaust gas emitted from internal-combustion engines using gasoline or light oil as fuel. Ammonia components are used as reducing agents for removing nitrogen oxide. Catalysts for such nitrogen oxide removal are called selective catalytic reduction (SCR) catalysts, and zeolites for use as primary materials are modified with a copper or iron element or the like to promote their activity.

The catalysts for use in the purification of exhaust gas emitted from internal-combustion engines need to exert purification performance over a long period and are required to have high durability. However, the exhaust gas emitted from internal-combustion engines contains various components that reduce the activity of catalytic components. Such an activity-reducing component in the exhaust gas is moisture that is supplied in a high-temperature state, for zeolites. The moisture in the exhaust gas is generated in a large amount by the combustion of hydrocarbon in fossil fuel with oxygen. Hence, the zeolites in the exhaust gas are always in a state exposed to high-temperature moisture.

The zeolites for exhaust gas purification catalysts are required to have durability against such moisture that is supplied at a high temperature. This is also called hydrothermal durability. Various approaches have been proposed for improvement in the hydrothermal durability of the zeolites for exhaust gas purification catalysts. The modification of zeolites with a phosphorus element is known as one of the approaches of improving such hydrothermal durability (Non Patent Literature 1).

In Non Patent Literature 1, a zeolite is impregnated with a phosphoric acid compound in order to increase the durability of the zeolite. This protects an aluminum element, which reportedly has relatively low durability, in the zeolite structure with a phosphorus element, thereby reportedly improving the durability of the zeolite.

The aluminum element is contained in the framework structure of the zeolite. In Non Patent Literature 1, the aluminum element is modified with a phosphorus element by impregnating the zeolite with an aqueous solution of a phosphorus compound, followed by heating so that the phosphorus element enters pores in the framework structure of the zeolite.

Non Patent Literature 1 describes a zeolite having an MFI structure as the zeolite to be modified with a phosphorus element. In the zeolite having an MFI structure, pores derived from a 10-membered oxygen ring structure are formed, and the size of the pores is as large as more than 5 angstroms. Therefore, the aluminum element in the zeolite structure is relatively easy to modify with a phosphorus element.

By contrast, pores in the framework structure of a small-pore zeolite of CHA, AEI, or AFX type are derived from an 8-membered oxygen ring structure and have a pore size that falls below 4 angstroms even at the maximum. Therefore, the approach of a phosphorus element to an aluminum element in the zeolite framework structure is more difficult than that in a zeolite having pores with a large size, such as the MFI-type zeolite.

For example, in the case of using diammonium hydrogen phosphate, which is easily obtained as a compound containing a phosphorus element, as a phosphorus element starting material, the diammonium hydrogen phosphate is known to become ammonium dihydrogen phosphate through the dissociation of ammonia at 155° C. The ammonium dihydrogen phosphate is known to become a high-molecular incombustible polymer ammonium metaphosphate at 216° C. or higher. Hence, modification by impregnation and heating using a phosphorus compound that is polymerized in a phosphorus modification step has the difficulty in modifying an aluminum element in a zeolite structure having small pores, such as a CHA-, AEI-, or AFX-type zeolite, with a phosphorus element, and hydrothermal durability is considered difficult to improve by this approach (Non Patent Literatures 2 and 3).

Hence, the modification of a CHA-, AEI-, or AFX-type zeolite with a phosphorus element reportedly requires an approach of blending orthophosphoric acid during zeolite synthesis and introducing a phosphorus element into a structural framework at a stage of a synthesis process (Patent Literature 1), or using a structure-directing agent containing a phosphorus element at the stage of synthesis to introduce the phosphorus element into pores outside the framework structure (Patent Literature 2). When the framework structure contains a phosphorus element as shown in Patent Literature 1, the phosphorus element is taken up, as in silicon, as a T atom (which refers to an atom constituting the framework structure of the zeolite, and T is an abbreviation of tetrahedral) in the zeolite framework structure. The phosphorus atom thus incorporated in the framework structure may be less stable than an aluminum atom which is also incorporated as a T atom.

When the zeolite structure has a phosphorus atom and an aluminum atom, a pentavalent phosphorus atom and a trivalent aluminum atom reportedly constitute a tetrahedron structure TO₄ unit similar to silicon and their TO₄ units are alternately linked so that electric neutrality is maintained. This linkage allows the zeolite containing a phosphorus atom and an aluminum atom in the framework structure to have framework flexibility, and facilitates introducing diverse transition metals which reportedly promote catalytic activity into cation sites (Non Patent Literature 4). However, this flexibility may probably lead to low durability. An aluminum phosphate framework is vulnerable to liquid water. When the zeolite structure has a phosphorus atom and an aluminum atom, reduction in durability is also of concern in an environment where water in the state of water vapor becomes liquid water by the coagulation of the water. Examples of such an environment include exhaust gas from automobiles equipped with a large diesel engine. The exhaust gas of the large diesel engine has a relatively low temperature among internal-combustion engines. Moisture in the exhaust gas may be condensed in a catalyst when placed in a low-revolution operating state for a long time in a cold environment. In this state, reduction in performance is of concern when a zeolite is used as a SCR catalyst.

The zeolites for use as catalysts for purifying exhaust gas emitted from internal-combustion engines are required to have high reactivity (activity), in addition to such hydrothermal durability. Abundance of cation sites in the zeolite structure are known as an index for such zeolites having high reactivity.

A zeolite containing silicon as well as an atom such as aluminum as T atoms constituting its framework structure locally has negative charge in the framework structure when a lattice composed of tetravalent silicon atoms contains atoms having a different valence, such as trivalent aluminum. Such negative charge is called cation site. The cation site can promote the adsorption of a reactant into pores in the zeolite structure and improve reactivity in a catalyst. The modification of this cation site with a positively charged transition metal such as copper or iron is also known to further promote the reactivity of the zeolite.

As for such a zeolite consisting of silicon and aluminum, silicon and aluminum in the zeolite may be indicated by SAR (silica alumina ratio), a [silica/alumina] ratio. When this SAR is small, the zeolite is regarded as a zeolite that contains a large amount of an aluminum element and is rich in cation site.

However, the zeolite rich in cation site might be dealuminated in a hydrothermal environment. This is presumably because a proton H⁺ acts on oxygen of Si—O—Al in the zeolite to break the bond. If such dealumination progresses, the framework structure of the zeolite is broken. Hence, a zeolite containing a large amount of an aluminum element in the framework structure can be expected to have high activity and however, is inferior in hydrothermal durability and can rarely be expected to have high durability when used as a catalytic component for exhaust gas purification for internal-combustion engines.

### CITATION LIST

### Patent Literature

Patent Literature 1: Japanese Translation of PCT International Application Publication No. 2014-528394
Patent Literature 2: Japanese Patent Laid-Open No. 2017-048106

### Non Patent Literature

Non Patent Literature 1: T. Blasco et al., J. Catal., 237 (2006) 267-277
Non Patent Literature 2: Feb. 28, 2018 “Synthesis of durable zeolite and application to SCR catalyst”, Tsuneji Sano, Abstract of the International Sympodium of the Society of Automotive Engineers of Japan, Inc., p. 43-47
Non Patent Literature 3: Tsuneji Sano, Nao Tsunoji, Catalysts & Catalysis, 60 (2018) 240-246
Non Patent Literature 4: Yoshio Ono, Tatsuaki Yashima, “Science and Engineering of Zeolites” (2000), 10-11

### SUMMARY OF INVENTION

### Technical Problem

For such a zeolite containing an aluminum element in the framework structure, improvement in hydrothermal durability may be attempted by modification with a phosphorus element as described above. However, the phosphorus element binds to a cation site so that reactivity might be reduced in turn due to the cation site, even if durability is improved.

In the case of conventionally improving the durability of a zeolite having small pores, such as CHA-, AEI-, or AFX-type zeolite, by modification with a phosphorus element, an approach of synthesizing the zeolite using a phosphonium compound as a structure-directing agent has also been reported, as mentioned above (Patent Literature 2). However, the phosphonium compound is generally an expensive compound, and toxicity is of concern depending on the compound. Thus, the compound is not preferred as an industrial material.

In an approach of adding a phosphonium compound at the stage of zeolite synthesis, cation sites of the resulting zeolite might be uniformly modified with a phosphorus element. The phosphorus element itself can rarely be expected to contribute to catalytic reaction. In this case, reactivity that exploits the cation sites in the zeolite might be reduced. The resulting zeolite may not have high activity as a catalytic material.

The present invention has been made in light of the problems described above. An object of the present invention is to provide a CHA-, AEI-, or AFX-type small-pore zeolite (hereinafter, also simply referred to as CHA, AEI, or AFX) with high activity and high hydrothermal durability having an 8-membered oxygen ring structure, and to provide an inexpensive method for producing such CHA, AEI, or AFX with high activity and high hydrothermal durability.

### Solution to Problem

The present inventors have conducted diligent studies to attain the object and found that CHA, AEI, or AFX excellent in hydrothermal durability can be obtained by modifying CHA, AEI, and AFX having a completed framework structure with a phosphorus element. The present inventors have also found an inexpensive method for producing this CHA, AEI, or AFX. On the basis of these findings, the present invention has been completed.

Specifically, the first aspect of the present invention is a CHA-, AEI-, or AFX-type small-pore zeolite comprising at least an aluminum element, a silica element, and a phosphorus element, wherein a content of the phosphorus element is defined by the following expression, and the small-pore zeolite has an 8-membered oxygen ring structure:

P1<P2

P1: [a ratio (at %) of the phosphorus element to the aluminum element according to X-ray fluorescence (XRF) analysis]

P2: [a ratio (at %) of the phosphorus element to the aluminum element according to X-ray photoelectron spectroscopy (XPS)]

The second aspect of the present invention is a CHA-, AEI-, or AFX-type small-pore zeolite comprising at least an aluminum element, a silica element, and a phosphorus element, wherein a content ratio of the phosphorus element is defined by the following expression, and the small-pore zeolite has an 8-membered oxygen ring structure:

P2/P1=2to 20

P1: [a ratio (at %) of the phosphorus element to the aluminum element according to X-ray fluorescence (XRF) analysis]

P2: [a ratio (at %) of the phosphorus element to the aluminum element according to X-ray photoelectron spectroscopy (XPS)]

The third aspect of the present invention is a method for producing a phosphorus element-containing zeolite, comprising impregnating CHA, AEI, AFX comprising at least an aluminum element and a silica element and having an 8-membered oxygen ring structure with an aqueous solution containing phosphoric acid or phosphate and an organic base that neutralizes the phosphoric acid or the phosphate.

### Advantageous Effects of Invention

The present invention can provide CHA, AEI, or AFX that can be expected to have high hydrothermal durability and high activity by increasing the content of a phosphorus element in a surface layer of the zeolite and decreasing the content of the phosphorus element in the inside thereof, whereby the number of phosphorus element-unmodified cation sites is increased in the inside of the zeolite while the number of phosphorus element-modified cation sites is increased in the zeolite surface layer which is most easily exposed to a hydrothermal atmosphere in an environment of usage as a catalyst. Furthermore, CHA, AEI, or AFX that is rich in phosphorus element in a zeolite surface layer and has a small content of a phosphorus element in the inside thereof can be obtained by a very simple operation of impregnation with an aqueous solution containing phosphoric acid or phosphate which is inexpensive as a phosphorus element starting material, and an organic base that neutralizes the phosphoric acid or the phosphate.

### DESCRIPTION OF EMBODIMENTS

Hereinafter, embodiments of the present invention will be described in detail. The embodiments given below are exemplary embodiments of the present invention, and the present invention is not limited by these embodiments. The present invention can be carried out by making arbitrary changes or modification therein without departing from the spirit of the present invention. In the present specification, the term “to” flanked by numeric values or physical property values is used to include the values before and after the term “to”. For example, a numeric range indicated by “1 to 100” encompasses both the lower limit value “¹” and the upper limit value “100”. The same holds true for the notations of other numeric ranges.

<Phosphorus Element-Containing Zeolite>

The phosphorus element-containing zeolite of the present embodiment comprises at least an aluminum element, a silica element, and a phosphorus element, wherein a content of the phosphorus element satisfies the expression (1) given below, and the phosphorus element-containing zeolite has an 8-membered oxygen ring structure selected from the group consisting of CHA, AEI, and AFX types. In this context, in the expression (1), P1 represents a ratio (at %) of the phosphorus element to the aluminum element according to X-ray fluorescence (XRF) analysis, and P2 represents a ratio (at %) of the phosphorus element to the aluminum element according to X-ray photoelectron spectroscopy (XPS).

P1<P2 (1)

[CHA, AEI, AFX]

In the present specification, CHA, AEI, or AFX is a code that represents a framework structure registered in IZA, and has an 8-membered oxygen ring structure. The size of pores formed by this 8-membered oxygen ring structure is reportedly CHA [3.8×3.8], AEI [3.8×3.8], and AFX [3.4×3.6] in terms of an angstrom unit. Hence, CHA, AEI, or AFX has small pores as compared with a widely known MFI-type zeolite having pores larger than 5 angstroms.

CHA, AEI, or AFX comprises at least an aluminum element, a silica element, and a phosphorus element. The aluminum element forms a cation site in the CHA, AEI, or AFX framework structure, as mentioned above. The amount of the aluminum element in CHA, AEI, or AFX of the present embodiment is not particularly limited, and the advantageous effects of the present invention can be expected as long as the aluminum element is contained in the framework structure. The alumina-based amount of the aluminum element indicated by SAR (molar ratio represented by SiO₂/Al₂O₃) is preferably 5 to 100, more preferably 10 to 50. SAR is further preferably 12 to 17. SAR having a certain level of magnitude attains high stability and durability of the framework structure. When SAR is not too large, cation sites are present in a sufficient amount capable of contributing to catalytic reaction. In the present embodiment, durability can be improved even for CHA, AEI, or AFX having small SAR which is reportedly inferior in hydrothermal durability in general.

When CHA, AEI, or AFX is in a particle form, its particle size is not particularly limited. On the other hand, in order to allow the amount of the phosphorus element contained to differ between the surface layer and the inside of the particle as mentioned later, the whole particle might be uniformly impregnated with the phosphorus element if the particle size is too small. Due to such concern, the size of the CHA, AEI, or AFX particle is preferably 0.5 to 20 μm, more preferably 1 to 5 μm, in terms of the size of crystalline particles (average particle size D50). If the particle size is too large, the access of a reactant to the central part of the particle is deteriorated in catalytic reaction. Even when CHA, AEI, or AFX is used as a catalytic component for exhaust gas purification for internal-combustion engines, activity commensurate with the amount of the zeolite used may be difficult to obtain. In the present specification, the average particle size D50 means a median size that is measured using a laser diffraction particle size distribution measurement apparatus (e.g., manufactured by Shimadzu Corp., laser diffraction particle size distribution measurement apparatus SALD-7100). The particle shape of CHA, AEI, or AFX is not particularly limited, and, for example, any of cuboidal, spheric, ellipsoidal, fractured, flat, and amorphous shapes may be used.

When CHA, AEI, or AFX is in a particle form, the particle may be any of a single-crystal particle, a polycrystalline particle, and a cluster particle. The particle may be a secondary particle composed of a plurality of crystalline particles held and joined together, or may be CHA, AEI, or AFX supported by coating on a structural support such as a honeycomb. Thus, CHA, AEI, or AFX is applicable in diverse forms and states, and the particle form is preferably a single-crystal particle because hydrothermal durability is improved by the uniform phosphorus modification of the particle surface layer.

[State of Phosphorus Modification]

A feature of the phosphorus element-containing zeolite of the present embodiment relates to the amount, i.e., distribution, of the phosphorus element in the surface layer and the inside of CHA, AEI, or AFX. In this context, the amount (distributed state) of the phosphorus element is defined by analysis using X-ray photoelectron spectroscopy (XPS) and X-ray fluorescence (XRF) analysis. Hence, the distribution of the phosphorus element is not limited by, for example, geometrically defined particles, regarding particles. The particles in the distribution of the phosphorus element refer to a particle ensemble, i.e., particles meant to correlate with analysis results from a bulk. In light of such a definition, the amount of the phosphorus element in a particle in the present specification refers to the amount of the phosphorus element analyzed as the whole of this bulk, unless otherwise specified.

[X-Ray Photoelectron Spectroscopy (XPS)]

In XPS, sample surface is irradiated with X-ray, and a constituent element of the sample and the electron state thereof are analyzed from the energy of the resulting photoelectrons. As a result, the type of the element and the quantification thereof can be determined or performed from the electron state at a depth of several nm to several tens of nm from the sample surface layer. In Examples given below, an apparatus under the name of PHI Quantera SXM manufactured by ULVAC-PHI, Inc. is used in XPS, and a surface layer phosphorus element concentration is defined by a phosphorus element concentration measured with an excitation line of monochromatic Al-Kα of approximately 1.5 keV. In the present specification, the same holds true for the description other than Examples, unless otherwise specified.

[X-Ray Fluorescence (XRF) Analysis]

In the XRF analysis, difference in energy between an inner shell and an outer shell inherent in each element released by the irradiation of the element with specific X-ray at more than fixed energy is analyzed. As a result, the type of an element constituting the sample and the quantification thereof can be determined or performed up to a depth of several tens of m of the sample in general specification of XRF.

[Phosphorus Element Ratio]

In the phosphorus element-containing zeolite of the present embodiment, the phosphorus element is contained in CHA, AEI, or AFX, and the distribution thereof has a feature. Specifically, in the phosphorus element-containing zeolite of the present embodiment, the amount of the phosphorus element quantified as a compositional ratio of constituent elements by use of XPS is larger than the amount of the phosphorus element quantified as a compositional ratio of constituent elements in the whole particle by use of XRF analysis.

XRF analysis does not unambiguously quantify the amount of the phosphorus element in the inside of the particle because a constituent element ratio of the whole particle is determined. However, the phosphorus element content of the whole particle (whole bulk) based on the surface layer is determined by comparing the results of XRF analysis with results of XPS. As a result, CHA, AEI, or AFX can be detected as containing the phosphorus element in a small amount in the inside and containing the phosphorus element in a large amount in the surface layer.

In the phosphorus element-containing zeolite of the present embodiment, the ratios of the phosphorus element contents quantified by XPS and XRF, i.e., the ratios of the phosphorus element in the sample surface layer and in the inside of the sample, can be represented by the expression (2): P2/P1 wherein the phosphorus element content (at %) of the whole particle quantified by XRF is defined as P1, and the phosphorus element content (at %) of the particle surface layer quantified by XPS is defined as P2. In such a case, P2/P1 is preferably 2 to 20, more preferably 2 to 15. If P2/P1 is too large, CHA, AEI, or AFX surface is covered with excess phosphorus elements. This state may hinder reaction that exploits original pores derived from the framework structure of the zeolite. If the ratio is too small, the CHA, AEI, or AFX surface layer cannot be sufficiently modified with the phosphorus element. As a result, hydrothermal durability may not be sufficiently improved.

[Production Process]

The phosphorus element-containing zeolite of the present embodiment can be obtained by impregnating a small-pore zeolite particle CHA, AEI, or AFX having an 8-membered oxygen ring structure with an aqueous solution containing phosphoric acid or phosphate and an organic base that neutralizes the phosphoric acid or the phosphate. The neutralization can prevent an aluminum atom from being eliminated from CHA, AEI, or AFX due to the phosphoric acid or the phosphate. The neutralization also prevents the polymerization of the phosphoric acid or the phosphate. This facilitates diffusing the phosphoric acid species into the pores of CHA, AEI, or AFX and can suppress the condensation of the phosphoric acid species outside the CHA, AEI, AFX pores even when the zeolite is heated for drying or the like. Thus, use of such a neutralizing solution enables phosphorus modification to be performed in one step for obtaining the phosphorus element-containing zeolite of the present embodiment, and can simplify equipment required for the phosphorus modification and decrease a necessary amount of energy used. Therefore, this approach is industrially advantageous.

CHA, AEI, or AFX to undergo such phosphorus modification is not particularly limited and may contain, for example, an alkali metal ion such as a sodium ion, or a hydrogen ion as a counter cation. The step of phosphorus modification may be appropriately changed or an additional step may be performed, without departing from the spirit of the present invention. Examples of such a configuration of the step include the phosphorus modification of CHA, AEI, or AFX containing a sodium ion as a counter cation, followed by the replacement of the sodium ion with a hydrogen ion.

[Phosphoric Acid]

The phosphoric acid or the phosphate to impregnate CHA, AEI, or AFX is not particularly limited as long as the phosphoric acid or the phosphate is soluble in water. Phosphoric acid, sodium phosphate, ammonium phosphate, vinylphosphonic acid, or the like is preferred, and phosphoric acid is more preferred, from the viewpoint of price, easy availability, and safety.

The organic base that neutralizes the phosphoric acid or the phosphate is not particularly limited. The organic base is not particularly limited as long as the organic base has large solubility in water and can suppress the polymerization of the phosphoric acid or the phosphate when heated in a state mixed with the phosphoric acid or the phosphate. Examples of such an organic base include, but are not particularly limited to, tetraalkylammonium, pyridine, trialkylamine, dialkylamine, alkylamine, ethanolamine, ethylenediamine, piperazine, piperidine, morpholine, and N-alkylmorpholine. Among them, ethanolamine, morpholine, and N-alkylmorpholine are preferred from the viewpoint of having relatively small odor and rarely deteriorating a working environment. Morpholine or N-ethylmorpholine, which is not a strong base, is more preferred from the viewpoint of safety.

<Method for Producing a Phosphorus Element-Containing Zeolite>

[Production Process: Amount of Organic Base Used Based on Phosphoric Acid]

In the case of using phosphoric acid or phosphate and an organic base that neutralizes the phosphoric acid in phosphorus modification, the amount of the organic base used is not particularly limited and can be an amount that can neutralize the phosphoric acid or the phosphate, though the amount is not limited thereto, as mentioned later. The amount of the organic base is not particularly limited and is preferably 50 to 300 mol %, more preferably 80 to 250 mol %, further preferably 120 to 220 mol %, based on the total amount of the phosphoric acid and/or the phosphate. The phosphoric acid or the phosphate does not have to be completely neutralized as long as the inside of CHA, AEI, or AFX can be impregnated with a predetermined amount of the phosphoric acid or the phosphate and as long as CHA, AEI, or AFX surface is not coated with a large excess of polymerized phosphoric acid or phosphate.

[Production Process: Amount of Mixed Aqueous Solution (Phosphoric Acid-Organic Base) Used]

For the phosphorus modification of CHA, AEI, or AFX, it is preferred to use a mixed aqueous solution of the phosphoric acid or the phosphate and the organic base, as mentioned above. The amount of the mixed aqueous solution used is preferably 70 to 120% by mass, more preferably 90 to 110% by mass, of the saturated water content of CHA, AEI, or AFX to be impregnated with the mixed aqueous solution. If the amount of the mixed aqueous solution for impregnation is too small, sufficient phosphorus modification of CHA, AEI, or AFX may not be attained. If the amount is too large, the phosphoric acid or the phosphate and the organic base go to waste. In the present specification, the saturated water content is determined by drying CHA, AEI, or AFX in the atmosphere of 120° C. for 6 hours or longer, leaving the dried zeolite standing for 1 hour in water, filtering the resultant, and regarding a mass increased from the dry mass as a water content percentage of 100% by mass.

[Production Process: Drying, Calcination]

In the case of using phosphoric acid or phosphate and an organic base that neutralizes the phosphoric acid, treatment after impregnation with the mixed aqueous solution is arbitrary and is preferably drying and calcination. In the case of performing drying and calcination, the temperature or atmosphere thereof is not particularly limited. For drying, the temperature is preferably 100 to 200° C., more preferably 130 to 190° C., most preferably 140 to 180° C., in the atmosphere. The drying time is not particularly limited and is basically preferably 1 hour or longer.

In the method for producing a phosphorus element-containing zeolite according to the present embodiment, calcination treatment is arbitrary, as mentioned above. Calcination for the purpose of decomposing the phosphoric acid species is preferably performed at 300 to 800° C. in the atmosphere. Too low a temperature may be unable to sufficiently decompose the phosphoric acid, and too high a temperature may incur defects in the framework concept, pore shape, or particle shape of CHA, AEI, or AFX.

<Physical Property and Purpose>

[Hydrothermal Durability Condition]

The phosphorus element-containing zeolite of the present embodiment has excellent hydrothermal durability. An evaluation method therefor is not particularly limited and can be appropriately determined, for example, by simulating an environment of usage. As an example of such an evaluation method, the crystallinity of CHA, AEI, or AFX before phosphorus modification analyzed by use of powder X-ray fluorescence diffraction (XRD) analysis is used as a denominator, and the crystallinity of the phosphorus element-containing zeolite after a hydrothermal durability test following phosphorus modification is used as a numerator. The results are indicated by percentage, and the resulting relative crystallinity can be used in the evaluation.

[Catalyst Purpose]

The phosphorus element-containing zeolite of the present embodiment is not particularly limited by its purpose and is preferably used as a catalyst for purifying exhaust gas emitted from internal-combustion engines, particularly, a catalyst for purifying exhaust gas emitted from automobiles using gasoline or light oil as fuel, because of its excellent hydrothermal durability in a high-temperature environment.

For the purpose of purifying exhaust gas emitted from large diesel automobiles such as trucks or buses, the phosphorus element-containing zeolite for automobile purposes is preferably used as a filter catalyst that captures fine particle components such as soot emitted from these large automobiles, or a selective catalytic reduction catalyst that is located downstream of this filter catalyst and removes NOx by using an ammonia component as a reducing agent. The filter catalyst may assume high heat when the filter is regenerated by removing the captured fine particle components such as soot through combustion. The selective catalytic reduction catalyst located downstream of the filter is exposed to heat during the filter regeneration. Therefore, the excellent hydrothermal durability effect of the phosphorus element-containing zeolite of the present embodiment is exerted to the full extent.

### EXAMPLES

Hereinafter, features of the present invention will be described further specifically with reference to Examples and Comparative Examples of the present invention. However, the present invention is not limited by Examples given below. Specifically, the specification of materials, amounts of the materials used, ratios, treatment contents, treatment procedures, etc. shown in Examples given below can be appropriately changed within the scope intended by the present invention without departing from the spirit of the present invention, as a matter of course. The values of various production conditions or evaluation results in Examples given below mean preferred upper limit values or preferred lower limit values for embodiments of the present invention, and preferred ranges may be ranges defined by combinations of the values of the upper limits or the lower limits described above and values of Examples or combinations of the values of Examples described below.

[Seed Crystal: Preparation of FAU-Type Zeolite (SAR=14.0)]

For the synthesis of a phosphorus-modified AFX-type zeolite according to one aspect of the present invention, an FAU-type zeolite for use as a silica/alumina source was provided. The FAU-type zeolite for use was dealuminated as follows in order to more improve the durability of the AFX zeolite to be synthesized.

84.0 g of 60% by mass of nitric acid was mixed with 4,000 g of water, and 400.0 g of an FAU-type zeolite HSZ-350HUA (manufactured by Tosoh Corp., silica alumina ratio SAR: 11.1) was added into the mixture with stirring. After stirring at room temperature for 24 hours, the mixture was subjected to solid-liquid separation and dried at 105° C. The FAU-type zeolite as a silica/alumina source thus dealuminated was analyzed by XRF. As a result, SAR was 14.0, confirming successful dealumination.

[Synthesis of AFX-Type Zeolite]

Subsequently, 17.9 g of an aqueous solution containing 4.8% by mass of sodium hydroxide, 18.8 g of an aqueous solution containing 19.43% by mass of N,N,N′,N′-tetraethylbicyclo[2.2.2]octane-2,3:5,6-dipyrrolidinium dihydroxide (manufactured by N. E. Chemcat Corp., molecular weight: 340.55) as a structure-directing agent for the AFX-type zeolite, 10.0 g of the dealuminated FAU-type zeolite (SAR=14.0) as a silica/alumina source, and 70.0 g of water were stirred in a stainless beaker for 16 hours. The composition of the mixture was as described below. The numeric values in the composition represent the ratios of the amounts of substances to the amount of substance of SiO₂ defined as 1.

| | SiO₂ |
|---|---|
| 0.071 | Al₂O₃ |
| 0.082 | OSDA²⁺ |
| 0.166 | Na⁺ |
| 0.330 | OH⁻ |
| 44.25 | H₂O |

Subsequently, this starting material composition (mixture) was placed in a 200 cc stainless autoclave and then stirred at 400 rpm at 20° C. for 16 hours using a stirring bar. Then, stirring was further held at 400 rpm at 160° C. for 240 hours. The product after this hydrothermal treatment was subjected to solid-liquid separation, and the obtained solid phase was washed with a sufficient amount of water and dried at 105° C. to obtain a product. The total amount of the obtained product was calcined at 600° C. for 5 hours while air was circulated. The product (solid phase) thus obtained was subjected to powder X-ray diffraction (XRD) analysis and consequently confirmed as a single-phase AFX-type zeolite. As a result of analyzing the product by XRF, SAR was 13.4. This calcined AFX-type zeolite was used in Reference Example 1 when relative crystallinity was determined.

### Example 1: Preparation of Phosphorus-Modified AFX-Type Zeolite

4.0 g of the calcined AFX-type zeolite of Reference Example 1 was impregnated with a mixed solution of 0.2 g (2.3 mmol) of morpholine (molecular weight: 87.12) as an organic base, 0.15 g (1.3 mmol) of 85% by mass of phosphoric acid, and 1.55 g of water in a container, and aged overnight in an environment of room temperature with the container closed. Subsequently, the zeolite was dried at 105° C. for 16 hours to obtain a phosphorus-modified AFX-type zeolite (SAR=13.4).

[Hydrothermal Durability Test]

1.0 g of the phosphorus-modified AFX-type zeolite powder of Example 1 was placed in a crucible, which was then placed in an electric furnace (trade name: OXK-600X, manufactured by Kyoei Electric Kilns Co., Ltd.) connected with a gas humidification apparatus (trade name: RMG-1000, manufactured by J-Science Lab Co., Ltd.), warmed to 950° C. under the supply of the atmosphere containing 10% water vapor at a flow rate of 70 L/min, and kept for 1 hour. Relative intensity was calculated from the peak intensity of powder X-ray diffraction of the obtained powder. The results are shown in Table 1, together with results about the other Examples and Comparative Examples.

### Comparative Example 1: Phosphorus-Unmodified AFX-Type Zeolite (SAR=13.4)

The phosphorus-unmodified calcined AFX-type zeolite powder of Reference Example 1 used in Example 1 was subjected to the same hydrothermal durability test and analysis by XRD as in Example 1. The results are shown in Table 1.

[Seed Crystal: Preparation of FAU-Type Zeolite (SAR=17.0)]

For the synthesis of a phosphorus-modified AFX-type zeolite according to one aspect of the present invention, an FAU-type zeolite for use as a silica/alumina source was provided. The FAU-type zeolite was dealuminated in the same manner as in [Seed crystal: Preparation of FAU-type zeolite (SAR=14.0)] in order to more improve the durability of the AFX zeolite except that 126.0 g of 60% by mass of nitric acid was used instead of 84.0 g of 60% by mass of nitric acid. As a result of analyzing the zeolite by XRF, SAR was 17.0.

[Synthesis of AFX-Type Zeolite]

Subsequently, 19.0 g of an aqueous solution containing 4.8% by mass of sodium hydroxide, 20.0 g of an aqueous solution containing 19.43% by mass of N,N,N′,N′-tetraethylbicyclo[2.2.2]octane-2,3:5,6-dipyrrolidinium dihydroxide (manufactured by N. E. Chemcat Corp., molecular weight: 340.55) as a structure-directing agent for the AFX-type zeolite, 11.0 g of the dealuminated FAU-type zeolite (SAR=17.0) as a silica/alumina source, and 70.0 g of water were stirred in a stainless beaker for 16 hours. The composition of the mixture was as described below. The numeric values in the composition represent the ratios of the amounts of substances to the amount of substance of SiO₂ defined as 1.

| | SiO₂ |
|---|---|
| 0.059 | Al₂O₃ |
| 0.075 | OSDA²⁺ |
| 0.151 | Na⁺ |
| 0.301 | OH⁻ |
| 38.67 | H₂O |

Subsequently, this starting material composition (mixture) was placed in a 200 cc stainless autoclave and then stirred at 400 rpm at 20° C. for 16 hours using a stirring bar. Then, stirring was further held at 400 rpm at 165° C. for 216 hours. The product after this hydrothermal treatment was subjected to solid-liquid separation, and the obtained solid phase was washed with a sufficient amount of water and dried at 105° C. to obtain a product. The total amount of the obtained product was calcined at 600° C. for 5 hours while air was circulated. The product (solid phase) thus obtained was subjected to powder X-ray diffraction (XRD) analysis and consequently confirmed as a single-phase AFX-type zeolite. As a result of analyzing the product by XRF, SAR was 16.0. This calcined AFX-type zeolite was used in Reference Example 2 when relative crystallinity was determined.

### Example 2: Preparation of Phosphorus-Modified AFX-Type Zeolite

A phosphorus-modified AFX-type zeolite (SAR=16.0) was obtained in the same manner as in Example 1 except that 4.0 g of the AFX-type zeolite of Reference Example 2 was used instead of the calcined AFX-type zeolite of Reference Example 1. This zeolite was subjected to the same hydrothermal durability test and analysis by XRD as in Example 1. The results are shown in Table 1.

### Comparative Example 2: Phosphorus-Unmodified AFX-Type Zeolite (SAR=16.0)

The phosphorus-unmodified calcined AFX-type zeolite powder of Reference Example 2 used in Example 2 was subjected to the same hydrothermal durability test and analysis by XRD as in Example 1. The results are shown in Table 1.

TABLE 1

| | | | Relative |
|---|---|---|---|
| | | | crystallinity |
| | | | after |
| | | | hydrothermal |
| | | | durability |
| | SAR | P/Al | test at 950° C. |
| Example 1 | 13.4 | 0.19 | 71% |
| Comparative Example 1 | 13.4 | 0 | 0% |
| Example 2 | 16.0 | 0.21 | 90% |
| Comparative Example 2 | 16.0 | 0 | 62% |

The relative crystallinity in Table 1 is comparison with the crystallinity before the hydrothermal durability test of the calcined AFX-type zeolite of Comparative Example 2. Although the calcined AFX-type zeolite was of Reference Example 1 (Comparative Example 1) or of Reference Example 2 (Comparative Example 2), the crystallinity determined by XRD diffraction as to Reference Example 2 (Comparative Example 2) expected to produce a high crystallinity owing to large SAR was defined as 100% and each crystallinity after the hydrothermal durability test was indicated by a relative value based thereon.

The results of Table 1 revealed that both the AFX-type zeolites of Example 1 and Example 2 which underwent phosphorus modification had high hydrothermal durability as compared with the phosphorus element-unmodified AFX-type zeolites of Comparative Example 1 and Comparative Example 2. Particularly, as is evident from the results about Example 1 and Comparative Example 1, hydrothermal durability was markedly improved in the zeolite reportedly having low SAR and generally low hydrothermal durability.

[Distribution Analysis of Phosphorus Element]

The amount of the phosphorus element in the whole particle was determined as the content percentage of the element in the whole bulk by XRF as to the phosphorus-modified AFX-type zeolites of Example 1 and Example 2. The results are shown in Table 2. The content percentage of the phosphorus element in the particle surface layer was also determined by XPS. The results are shown in Table 3. The numeric values in both Tables 2 and 3 represent atom %.

TABLE 2

| | O | Na | Al | Si | P |
|---|---|---|---|---|---|
| Example 1 | 64.80% | 2.65% | 3.97% | 27.83% | 0.75% |
| Example 2 | 65.53% | 1.31% | 3.58% | 28.83% | 0.75% |

TABLE 3

| | O | Na | Al | Si | P |
|---|---|---|---|---|---|
| Example 1 | 69.1% | 2.4% | 2.0% | 21.2% | 5.4% |
| Example 2 | 69.3% | 2.3% | 1.8% | 21.8% | 4.8% |

Considering that phosphorus elements are selectively adsorbed to cation sites in zeolites, the results of Tables 2 and 3 were summarized in Table 4 as to the ratio of the phosphorus element to the aluminum element in the particle surface layer and the concentration ratio of the phosphorus element to the aluminum element in the whole bulk (whole particle).

TABLE 4

| | | | Surface/ |
|---|---|---|---|
| | P/Al | P/Al | whole bulk |
| | (whole bulk) | (surface) | (P2/P1) |
| Example 1 | 0.19 | 2.72 | 14.3 |
| Example 2 | 0.21 | 2.66 | 12.7 |

As is evident from the results of Table 4, the phosphorus element was unevenly distributed and contained in the zeolite particle surface layer both in Example 1 and in Example 2.

Subsequently, an AEI-type zeolite was also treated in the same manner as in the AFX-type zeolite and tested for the effect of phosphorus modification of an AEI-type zeolite particle surface layer.

[Synthesis of AEI-Type Zeolite]

410.0 g of an aqueous solution containing 20.40% by mass of 1,1,3,5-tetramethylpiperidinium hydroxide (manufactured by SACHEM, Inc., molecular weight: 159.27), 350.0 g of water, 48.0 g of an FAU-type zeolite CBV-712 (manufactured by Zeolyst International, SAR=10.9) and 600.0 g of a sodium silicate J3 solution (manufactured by Nippon Chemical Industrial Co., Ltd., 29.0% SiO₂) were stirred in a stainless beaker for 1 hour. The composition of the mixture was as described below. The numeric values in the composition represent the ratios of the amounts of substances to the amount of substance of SiO₂ defined as 1.

| | SiO₂ |
|---|---|
| 0.015 | Al₂O₃ |
| 0.152 | OSDA⁺ |
| 0.540 | Na⁺ |
| 0.692 | OH⁻ |
| 17.03 | H₂O |

Subsequently, this starting material composition (mixture) was placed in a 1,200 cc stainless autoclave. Stirring was maintained at 70 rpm at 150° C. for 96 hours using a stirring bar, and then further held at 160° C. for 24 hours. The product after this hydrothermal treatment was subjected to solid-liquid separation, and the obtained solid phase was washed with a sufficient amount of water and dried at 105° C. to obtain a product. The total amount of the obtained product was calcined at 600° C. for 5 hours while air was circulated. The product (solid phase) thus obtained was analyzed by XRD and consequently confirmed as an AEI-type zeolite having a crystallinity of 90% or more. As a result of analyzing the product by XRF, SAR was 14.3. This calcined AEI-type zeolite was used in Reference Example 3 when relative crystallinity was determined.

### Example 3: Preparation of Phosphorus-Modified AEI-Type Zeolite

3.0 g of the calcined AEI-type zeolite synthesized as described above was impregnated with a mixed solution of 0.15 g (1.7 mmol) of morpholine (molecular weight: 87.12) as an organic base, 0.1 g (0.9 mmol) of 85% by mass of phosphoric acid, and 1.05 g of water in a container, and left and aged two nights with the container closed. Subsequently, the zeolite was dried at 105° C. for 16 hours to obtain a phosphorus-modified AEI-type zeolite (SAR=14.3). The ratio of the phosphorus element to the aluminum element (P/Al ratio) according to XRF was 0.16, and the content percentage (solid-based) of P was 1.0% by mass. This zeolite was subjected to the same hydrothermal durability test and analysis by XRD as in Example 1. The results are shown in Table 5, together with results about Example 4 and Comparative Example 3. The P/Al ratio was compared between the whole bulk and the surface in the same manner as in Example 1. The results are shown in Table 6.

### Example 4: Preparation of Phosphorus-Modified AEI-Type Zeolite

A phosphorus-modified AEI-type zeolite (SAR=14.3) was obtained in the same manner as in Example 3 except that: the amount of morpholine used in Example 3 was changed to 0.3 g (3.4 mmol); and 0.2 g (1.7 mmol) of vinylphosphonic acid (molecular weight: 108.03) and 0.8 g of water were used instead of 85% by mass of phosphoric acid. The ratio of the phosphorus element to the aluminum element (P/Al ratio) according to XRF was 0.31, and the content percentage (solid-based) of P was 1.9% by mass. This zeolite was subjected to the same hydrothermal durability test and analysis by XRD as in Example 1. The results are shown in Table 5. The P/Al ratio was compared between the whole bulk and the surface in the same manner as in Example 1. The results are shown in Table 6.

### Comparative Example 3: Phosphorus-Unmodified AEI-Type Zeolite

The phosphorus-unmodified calcined AEI-type zeolite powder used in Example 3 was directly subjected, without undergoing phosphorus modification, to the same hydrothermal durability test and analysis by XRD as in Example 1. The results are shown in Table 5. The P/Al ratio was compared between the whole bulk and the surface in the same manner as in Example 1. The results are shown in Table 6.

TABLE 5

| | | | Relative |
|---|---|---|---|
| | | | crystallinity |
| | | | after |
| | | | hydrothermal |
| | | | durability |
| | SAR | P/Al | test at 950 °C. |
| Example 3 | 14.3 | 0.16 | 76% |
| Example 4 | 14.3 | 0.31 | 61% |
| Comparative Example 3 | 14.3 | 0 | 40% |

TABLE 6

| | | | Surface/ |
|---|---|---|---|
| | P/Al | P/Al | whole bulk |
| | (whole bulk) | (surface) | (P2/P1) |
| Example 3 | 0.16 | 0.96 | 6.0 |
| Example 4 | 0.31 | 1.32 | 4.3 |

The relative value obtained by comparison when the crystallinity determined by XRD diffraction was defined as 100% as to the calcined AEI-type zeolite (Reference Example 3) before the hydrothermal durability test. As is evident from the results of Table 5, hydrothermal durability was also improved in the AEI-type zeolite owing to the phosphorus element unevenly distributed and richly contained in the surface layer of the zeolite particle by the same operation as in the AFX-type zeolite.

Subsequently, a CHA-type zeolite was also treated in the same manner as in the AFX-type zeolite and tested for the effect of phosphorus modification of a CHA-type zeolite particle surface layer.

[Synthesis of CHA-Type Zeolite]

1,220.0 g of an aqueous solution containing 25% by mass of N,N,N-trimethyladamantylammonium hydroxide (manufactured by SACHEM, Inc., molecular weight: 211.35), 1,710.0 g of water, 74 g of sodium hydroxide (guaranteed, manufactured by FUJIFILM Wako Pure Chemical Corp.), 590.0 g of Kyoward KW700SEN-S (manufactured by Kyowa Chemical Industry Co., Ltd., synthetic aluminum silicate), 880.0 g of Snowtex 40 (manufactured by Nissan Chemical Corp., 39.7% SiO₂), and 31.0 g of chabazite seed crystals (SAR16) were stirred in a stainless beaker for 1 hour. The composition of the mixture was as described below. The numeric values in the composition represent the ratios of the amounts of substances to the amount of substance of SiO₂ defined as 1.

| | SiO₂ |
|---|---|
| 0.053 | Al₂O₃ |
| 0.120 | OSDA⁺ |
| 0.190 | Na⁺ |
| 0.310 | OH⁻ |
| 15.06 | H₂O |

Subsequently, this starting material composition (mixture) was placed in a 5,000 cc stainless autoclave. Stirring was maintained at 300 rpm at 170° C. for 55 hours. After cooling, the product after this hydrothermal treatment was subjected to solid-liquid separation, and the obtained solid phase was washed with a sufficient amount of water and dried at 105° C. to obtain a product. The total amount of the obtained product was kept at 380° C. for 6 hours and then further calcined at 380° C. for 3 hours, at 440° C. for 3 hour, at 500° C. for 3 hours, and subsequently at 600° C. for 1 hour while air was circulated. The product (solid phase) thus obtained was analyzed by XRD and consequently confirmed as a CHA-type zeolite.

[Preparation of CHA-Type Zeolite]

519.0 g of the calcined CHA-type zeolite synthesized as described above was added to a solution containing 519.0 g of ammonium nitrate (guaranteed, manufactured by FUJIFILM Wako Pure Chemical Corp.) dissolved in 4152 g of water, heated and stirred, and kept at 80° C. for 2 hours or longer. After cooling, solid-liquid separation was performed, and the same operation as above was repeated. After solid-liquid separation, the solid phase was washed with a sufficient amount of water and dried at 105° C. to obtain a NH₄⁺ CHA-type zeolite. The total amount of the obtained product was kept at 120° C. for 2 hours and then calcined at 500° C. for 5 hours to obtain a H⁺ CHA-type zeolite. As a result of analyzing the zeolite by XRF, SAR was 15.2. This calcined H⁺ CHA-type zeolite was used in Reference Example 4 when relative crystallinity was determined.

### Example 5: Preparation of Phosphorus-Modified CHA-Type Zeolite

3.0 g of the H⁺ CHA-type zeolite synthesized as described above was impregnated with a mixed solution of 0.15 g (1.7 mmol) of morpholine (molecular weight: 87.12) as an organic base, 0.1 g (0.9 mmol) of 85% by mass of phosphoric acid, and 1.05 g of water in a container, and left and aged two nights with the container closed. Subsequently, the zeolite was dried at 105° C. for 16 hours to obtain a phosphorus-modified CHA-type zeolite (SAR=15.2). The ratio of the phosphorus element to the aluminum element (P/Al ratio) according to XRF was 0.20, and the content percentage (solid-based) of P was 1.19% by mass. This zeolite was subjected to the same hydrothermal durability test and analysis by XRD as in Example 1. The results are shown in Table 7, together with results about Example 5 and Comparative Example 4. The P/Al ratio was compared between the whole bulk and the surface in the same manner as in Example 1. The results are shown in Table 8.

### Comparative Example 4: Phosphorus-Unmodified CHA-Type Zeolite

The phosphorus-unmodified H⁺ CHA-type zeolite powder used in Example 5 was directly subjected, without undergoing phosphorus modification, to the same hydrothermal durability test and analysis by XRD as in Example 1. The results are shown in Table 7. The P/Al ratio was compared between the whole bulk and the surface in the same manner as in Example 1. The results are shown in Table 8.

TABLE 7

| | | | Relative |
|---|---|---|---|
| | | | crystallinity |
| | | | after |
| | | | hydrothermal |
| | | | durability |
| | SAR | P/Al | test at 950° C. |
| Example 5 | 15.2 | 0.20 | 48% |
| Comparative Example 4 | 15.2 | 0 | 30% |

TABLE 8

| | | | Surface/ |
|---|---|---|---|
| | P/Al | P/Al | whole bulk |
| | (whole bulk) | (surface) | (P2/P1) |
| Example 5 | 0.20 | 0.60 | 3.0 |

The relative value obtained by comparison when the crystallinity determined by XRD diffraction was defined as 100% as to the H⁺ CHA-type zeolite (Reference Example 4) before the hydrothermal durability test. As is evident from the results of Table 7, hydrothermal durability was also improved in the CHA-type zeolite owing to the phosphorus element unevenly distributed and richly contained in the surface layer of the zeolite particle by the same operation as in the AFX-type zeolite.

1. A phosphorus element-containing zeolite, comprising:
at least an aluminum element, a silica element, and a phosphorus element; wherein:
a content of the phosphorus element satisfies expression (1); and
the phosphorus element-containing zeolite has at least one 8-membered oxygen ring structure selected from the group consisting of CHA, AEI, and AFX:
P1<P2 (1)
wherein P1 represents a ratio (at %) of the phosphorus element to the aluminum element according to X-ray fluorescence (XRF) analysis, and P2 represents a ratio (at %) of the phosphorus element to the aluminum element according to X-ray photoelectron spectroscopy (XPS).

2. The phosphorus element-containing zeolite according to claim 1, comprising:
at least an aluminum element, a silica element, and a phosphorus element; wherein:
a content ratio of the phosphorus element satisfies expression (2); and
the phosphorus element-containing zeolite has at least one 8-membered oxygen ring structure selected from the group consisting of CHA, AEI, and AFX:
P2/P1=2to 20 (2)
wherein P1 represents a ratio (at %) of the phosphorus element to the aluminum element according to X-ray fluorescence (XRF) analysis, and P2 represents a ratio (at %) of the phosphorus element to the aluminum element according to X-ray photoelectron spectroscopy (XPS).

3. The phosphorus element-containing zeolite according to claim 1, wherein:
a silica alumina ratio [silica/alumina] is 5 to 100.

4. A method for producing a phosphorus element-containing zeolite, comprising:
impregnating a small-pore zeolite particle comprising at least an aluminum element and a silica element and having at least one 8-membered oxygen ring structure selected from the group consisting of CHA, AEI, and AFX with an aqueous solution containing phosphoric acid or phosphate and an organic base that neutralizes the phosphoric acid or the phosphate.

5. The method for producing a phosphorus element-containing zeolite according to claim 4, wherein:
the small-pore zeolite particle has a silica alumina ratio [silica/alumina] of 5 to 100.

6. The method for producing a phosphorus element-containing zeolite according to claim 4, wherein:
the phosphoric acid or the phosphate comprises at least one selected from the group consisting of phosphoric acid, sodium phosphate, ammonium phosphate, and vinylphosphonic acid.

7. The method for producing a phosphorus element-containing zeolite according to claim 4, wherein:
the organic base comprises at least one selected from the group consisting of tetraalkylammonium, pyridine, trialkylamine, dialkylamine, alkylamine, ethanolamine, ethylenediamine, piperazine, piperidine, morpholine, and N-alkylmorpholine.

8. The phosphorus element-containing zeolite according to claim 2, wherein:
a silica alumina ratio [silica/alumina] is 5 to 100.

9. The method for producing a phosphorus element-containing zeolite according to claim 5, wherein:
the phosphoric acid or the phosphate comprises at least one selected from the group consisting of phosphoric acid, sodium phosphate, ammonium phosphate, and vinylphosphonic acid.

10. The method for producing a phosphorus element-containing zeolite according to claim 5, wherein:
the organic base comprises at least one selected from the group consisting of tetraalkylammonium, pyridine, trialkylamine, dialkylamine, alkylamine, ethanolamine, ethylenediamine, piperazine, piperidine, morpholine, and N-alkylmorpholine.

11. The method for producing a phosphorus element-containing zeolite according to claim 6, wherein:
the organic base comprises at least one selected from the group consisting of tetraalkylammonium, pyridine, trialkylamine, dialkylamine, alkylamine, ethanolamine, ethylenediamine, piperazine, piperidine, morpholine, and N-alkylmorpholine.

12. The method for producing a phosphorus element-containing zeolite according to claim 7, wherein:
the organic base comprises at least one selected from the group consisting of tetraalkylammonium, pyridine, trialkylamine, dialkylamine, alkylamine, ethanolamine, ethylenediamine, piperazine, piperidine, morpholine, and N-alkylmorpholine.
